(19) United States
(12) Patent Application Publication
(10) Pub. No.: US 2005/0246908 A1
(43) Pub. Date: Nov. 10, 2005

(54) Hinged scribing tool with adjustable marking apparatus and rolling wheels

(76) Inventor: Joel Cotton, Virginia Beach, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 10/838,452

(22) Filed: May 4, 2004

(51) Int. Cl. B43L 13/02

(52) U.S. Cl. 33/41.5

(57) ABSTRACT

This invention is used for creating straight marks along floor coverings to guarantee that they can be cut perfectly to the dimensions of the area. The template has two straight edges that function as rulers. Both of these edges are hinged and are parallel to each other. The hinges allow the tool to be adjusted to fit and mark any area. In the center, between the hinged bars, there is a pencil holding plate that holds the scribing tool. This pencil is held in place by an adjustable wing nut enabling the pencil to be manipulated as necessary. Alternatively, in the second embodiment, the center plate may include graduated holes for accepting the pencil. Finally, the entire apparatus includes rolling wheels, allowing it to easily move along edges and mark the floor coverings.

There are no related applications.

The subject matter of this application received no federal research or development funding.

### BACKGROUND OF THE INVENTION

Generally, the invention relates to a tool for use in assisting an installer of flooring material. More particularly, the invention is directed towards a scribing tool that may be used to accurately mark flooring material to be cut by an installer of flooring material. The scribing tool is used to mark the flooring material to accurately reflect the profile of the wall or other surface against which the flooring material is installed.

When installing certain types of flooring material such as VCT tile, ceramic, marble, hardwood, laminate, luan or carpet, it is sometimes necessary to cut the flooring material when an installer encounters an odd-shaped room. Likewise, it is necessary for an installer to cut tile when the floor size is not large enough to accommodate whole sizes of the tile. Therefore, the installer must mark the flooring material and cut it to fit the size of the floor to be covered.

Traditionally, an installer will measure the dimensions of a room by sampling a single distance between two walls at one edge of the wall and repeating this process at the opposite edge of the wall to yield the size of a floor to be covered. The installer then cuts a sheet of flooring material, such as VCT tile, ceramic, marble, hardwood, laminate, luan or carpet, to the desired size and hauls it into the room having the floor to be covered. This process tends to be inaccurate since many walls are not plumb or straight. That is to say, the walls may include bulges, depressions or other such imperfection near the floor. Therefore, the installer must again trim the flooring material after the material has been laid onto the floor. This requires the installer to cut the material twice which tends to lead to increased labor costs and material loss. If the room is very much out of plumb, the installer may be required to cut a new piece of flooring. Thus, the current process for measuring rooms and installing flooring therein is somewhat inefficient and more costly than necessary.

Another problematic situation is experienced during the installation of tile. It is sometimes necessary to overlap and mark a second piece of tile onto an already laid piece of tile if the dimensions of the room are too small to accommodate a whole number of tiles. This situation may also occur when flooring or tile is installed around or against a curved surface. A mark is made on the second piece of tile that reflects the amount to be cut in order to fit the tile into the floor. Thus, it is necessary to cut pieces of tile if the dimensions of the floor cannot be divided equally by the dimensions of the tile. For example, if the size of a floor is twenty feet by twenty feet then twenty twelve inch square tiles can be easily fitted against each wall. It should be noted that spacing between the tiles has been eliminated in this example for ease in understanding the invention. However, should a nine inch square tile be used as flooring material, it will be necessary to lay 26.67 tiles along each wall to cover the floor. This requires the installer to cut at least 20 tiles or one entire row of tiles. It is also very difficult for an installer to accurately mark flooring material to be installed against or around curved surfaces.

Ordinarily, the installer will begin setting the tile in one corner of the room along a wall. The installer continues laying tile until a row of tile is laid against the wall. The installer then begins laying a second row of tile at a desired spacing from the first row. This process continues until the installer has reached the far wall of the room. If the installer does not recognize imperfections within the walls of the room, the last row of tiles to be laid may greatly reflect the imperfections. Moreover, if it is necessary to cut tiles in order to make the last row of tiles fit, the installer butts a fresh tile against the far wall or a spaced distance therefrom and marks the tile for cutting where it overlays the previous laid row of tile. This process becomes problematic if the tile includes a design since the installer desires to place the cut edge against a wall to be covered by trim material. The present invention overcomes these problems by providing a scribing tool that can be used to mark a floor or flooring material to be cut. Moreover, the present invention may be used to create a grid work of lines that reflects bulges, recesses, or other imperfections present in a wall as well as curved surfaces. This grid work of lines may be used for placing tiles.

### BRIEF SUMMARY OF THE INVENTION

The present invention is an adjustable template tool designed to assist individuals when installing VCT tile, ceramic, marble, hardwood, laminate, luan, or carpet, and related floor coverings that are cut to fit an area of a floor. Thus, the apparatus offers a solution to the difficult task of installing floor coverings to the exact dimensions of the area in question as mentioned above. It may also be used to create a grid work of lines for placing tiles. The grid work of lines accounts for imperfections in a wall to assure that tiles are placed an equal distance from a wall. The imperfections of the wall may then be hidden by appropriately varying the spacing of the tiles throughout the remaining portion of the floor.

As previously mentioned, installation of floor coverings could be a difficult task. The new floor covering must be able to cover the area in question fully. In many instances, tiles must be cut to fit the dimensions of the floor. The process of marking and cutting the covering is problematic and often results in miscalculated cuts that leave gaps between the covering and the walls of the room. These gaps must be small enough to be covered by trim material or new flooring material must be cut to the correct dimensions. These problems are exacerbated by imperfections in walls of the room.

The template tool is a wheeled scribing tool with an adjustable marking apparatus. In one embodiment, the scribing tool includes a wheel that contacts the wall to insure that the mark scribed for cutting the flooring material is the correct dimensions. The wheel moves parallel to the floor surface and along the wall to cause a mark created by the scribing tool to account for irregularities or curves in the surface of the wall. Thus, if the wall bulges or recedes, the mark on the floor will reflect the irregularity in the wall. The covering may be marked and cut to lay perfectly in the room.

In another embodiment, the tool is equipped with a marking device, such as a pencil, held by an adjustable fastening device that allows the marking device to be adjusted to make its mark. The adjustable fastening device may be a hollow wing nut that tightens around a threaded extension of a plate. The marking device, for example a pencil, marker or other such marking implement, passes through the wing nut and the threaded extension such that the marking end of the device contacts the floor or flooring material. The tool may include a pointer that is aligned with a mark or line on the floor for ensuring that tile is appropriately spaced apart. Thus, the marking device and the pointer may be used to create a series of intersecting lines to create a grid work of lines for accurately installing tiles onto a floor. The tool may also be used to mark flooring material to be cut.

In another embodiment, the tool is equipped with holes at predetermined locations and positions. The pencil or other marking device may then be dropped into an appropriate hole in order to mark the floor covering. The pointer may be used in this embodiment to create the grid work previously mentioned.

The tool includes swivel-mounted wheels for rolling across the floor or flooring material to be marked. In additional embodiments, the tool includes at least one straight edge that may readily used to mark materials and accurately take measurements. Finally, the tool might include hinged sides that are straight edges and may assume different elevations. These sides may also include graduated marks for taking measurements. This makes the tool more flexible by expanding the angles of material use and types of uses of the tool.

It is believed that no other scribing tool offers the multitude of characteristics of this tool. Every feature on the apparatus can be manipulated to match the individual tasks of each user. The innovation behind the flexibility of the tool makes it a distinct asset when compared to previous tools.

The tool can be used for various projects. One use of the tool is for marking floor coverings so that they can be cut to meet the dimensions of the room. The tool may also be used for installing tile, carpet or any other floor material to lessen the chance of mistakes created by inaccurate measurements. Any project that requires precision in marking is made easier by using this invention. It includes five tools in one; two straight edges, two measuring devices and a scribing tool.

An object of the invention is to provide an apparatus for the accurate and efficient marking and cutting of flooring material.

Another object of the invention is to provide an apparatus that accounts for irregularities in walls of rooms in which flooring material is to be installed. The flooring material to be installed is marked to account for these irregularities or curves. It is therefore unnecessary to re-cut the flooring material since irregularities in the room are accounted for during the marking process.

A further object of the invention is to provide a wheeled scribing apparatus that includes a wheel for traveling across a surface of a wall in a room in which flooring material is to be installed. The wheel glides along the wall causing the scribe to accurately mark the floor to reflect any surface irregularities curves.

A further object of the invention is to provide a wheeled scribing apparatus that includes at least one adjustable straight edge. The straight edge may be hingedly connected to the apparatus such that it can assume various elevations. The straight edge may include graduated marks such that it can be used as a measuring device.

These and other objects and advantages of the invention will be set forth, appear in part or become apparent after considering the specification and accompanying drawings. It is to be realized that the following embodiments of the invention have been represented in their simplest form for ease in understanding the invention.

### BRIEF DESCRIPTION OF THE DRAWINGS

FIG. 1 is an overhead plan of a first embodiment of the apparatus.

FIG. 2 is a perspective view of a first embodiment of the apparatus.

FIG. 3 is an overhead plan view of a second embodiment of the apparatus.

FIG. 4 is a perspective view of a second embodiment of the apparatus.

FIG. 5 shows the elevation view of the apparatuses shown in FIGS. 1-4.

FIG. 6 is an overhead plan of a third embodiment of the apparatus.

FIG. 7 is a perspective view of a third embodiment of the apparatus.

FIG. 8 is an overhead plan view of a forth embodiment of the apparatus.

FIG. 9 is a perspective view of a forth embodiment of the apparatus.

FIG. 10 shows an elevation view of the apparatuses shown in FIGS. 6-9.

FIG. 11 is an enlarged exploded view of a marking device holder.

FIG. 12 is a plan view of a room that includes a wall having a curved surface. This view shows how the scribing tool of the present invention transposes a line accurately reflecting the imperfection within the wall.

FIG. 13 includes a view of a grid work of lines created by the instant invention for use in setting tiles on a floor.

### DETAILED DESCRIPTION OF THE INVENTION

The scribing tool with adjustable marking device and rolling wheels is intended to mark the floor when measuring and installing floor coverings. The versatility of the tool provides that it may also be used in any project requiring precise measurements that can be conducted on the floor. The present invention is a scribing tool that includes an adjustment plate. The adjustment plate includes at least one opening that may be elongated or slot-shaped. Alternatively, the adjustment plate may include a plurality of holes or openings spaced equidistance from each neighboring opening.

A wing nut assembly including a washer plate and a bottom plate may be included for adjustably holding a marking device such that a line may be scribed in the shape of an object against which a tracing wheel passes. The tracing wheel may be secured to the fork at one end of the adjustment plate.

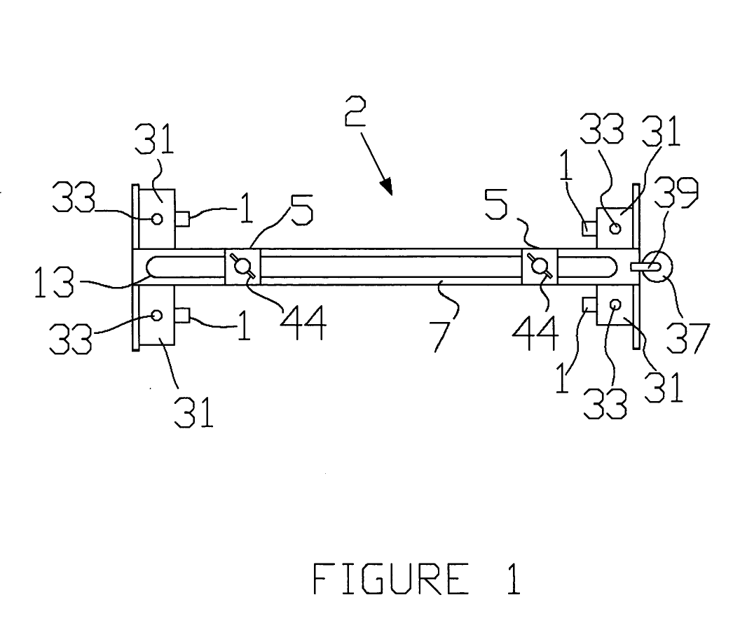

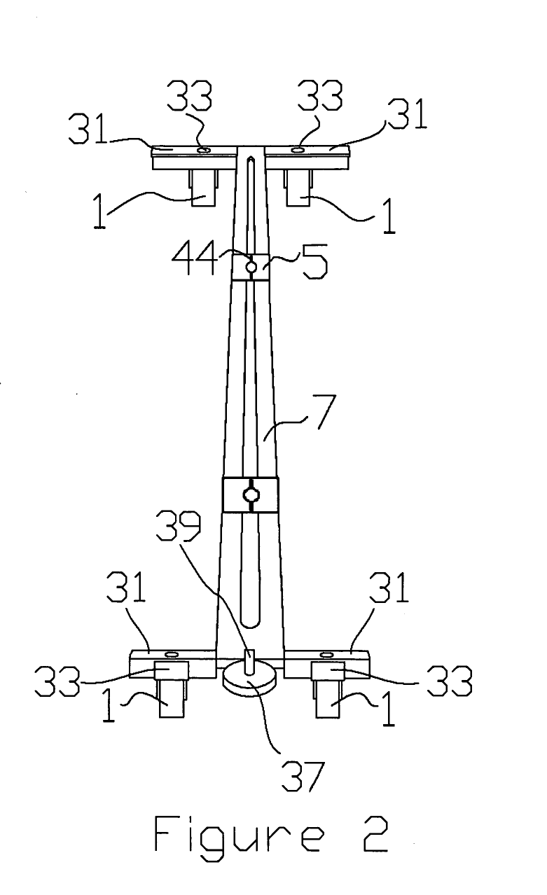

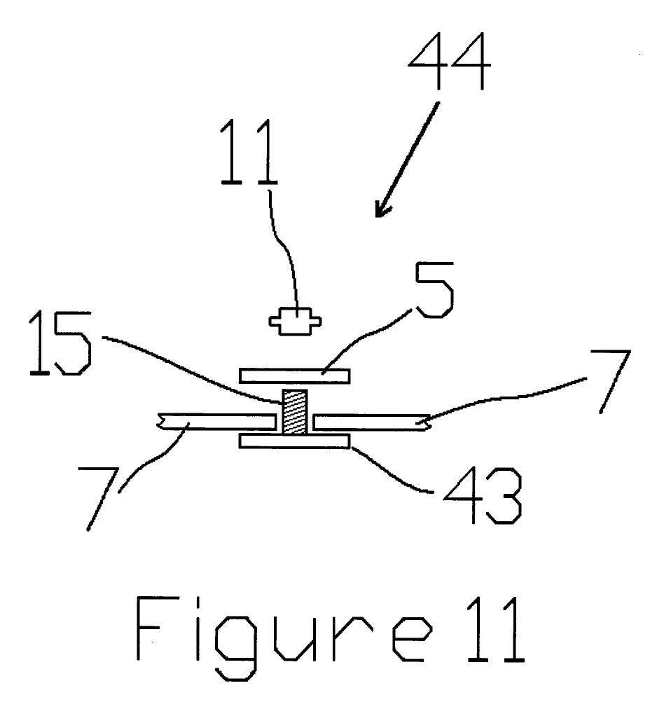

FIGS. 1 and 2 are overhead plan views of a first embodiment of the invention. The scribing tool 2 includes an adjustment plate 7 including an adjustment slot 13 in which a wing nut assembly 44 is adjustably affixed, as more clearly shown and described in FIG. 11 and its accompanying discussion hereinafter. The adjustment slot 13 is an elongated or elliptically shaped hole.

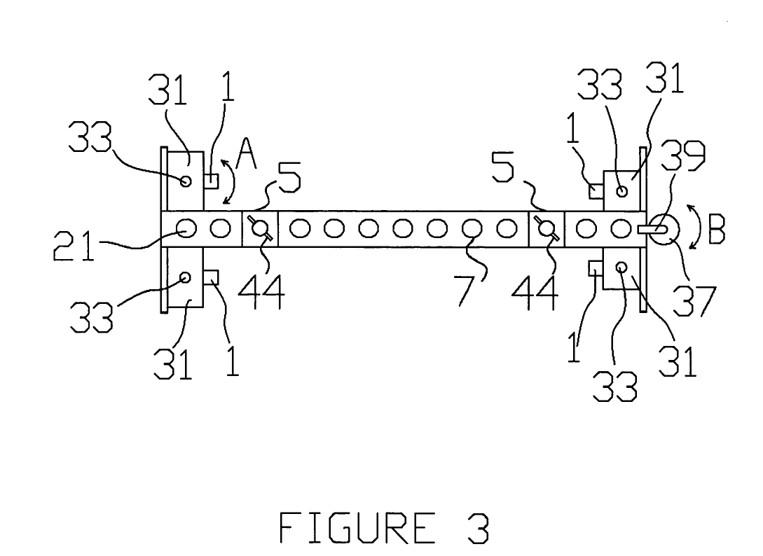

In the preferred embodiment, a pair of wheels 1 are affixed to wheel plates 33 by swivels 31 at opposite ends of the adjustment plate 7. The wheels 1 therefore swivel in a 360 degree fashion, depicted in FIG. 3 as Arrow A, such that the tool 2 may be easily glided across a floor or flooring material. Bearings, not shown, are included in the swivels 31 such that the wheels 1 may easily rotate.

A tracing wheel 37 is affixed to one end of the tool 2 via a fork 39. The fork 39 includes a portion that passes through a central opening in the wheel and includes bearings (not shown) disposed between the fork 39 and wheel 37 that allow wheel 37 to rotate as the tool 2 passes along a wall. The wheel 37 is arranged in a perpendicular manner to the floor upon which the tool 2 glides, as shown in FIGS. 1 and 2. The wheel 37 rotates in a direction shown by Arrow B in FIG. 3.

Two wing nut assemblies 44 including washer plates 5 are shown in the Figures. The wing nut assemblies 44 serve to secure the marking devices 41A and 41B at a desired location along the adjustment slot 13 as discussed hereinafter. The wing nut assemblies 44 may be used to scribe two lines at once such that the lines may be scribed at multiples of equal intervals from a wall. That is to say, one of the wing nut assemblies 44 may be positioned to scribe a line 6 inches from the wall or other such obstacle against which flooring material may be laid while a second wing nut assembly may mark a line at a different distance from the wall or obstacle. Thus, a template for cutting a flooring material may be traced upon the flooring material by gliding the tracing wheel 37 against an object to obtain an exact replica of the shape of the object on the flooring material. A first marking device 41A may be aligned over a previously scribed line while the other marking device 41 B may be adjusted to a desired working distance from the first. A second line having substantially similar characteristics and shapes may be created by propelling the device 2 across the floor while passing the first marking device 41A over the previously scribed line.

Washer plate 5 is preferably square in shape as shown. However, it should be recognized that a washer plate of different shape might be used in practicing the invention.

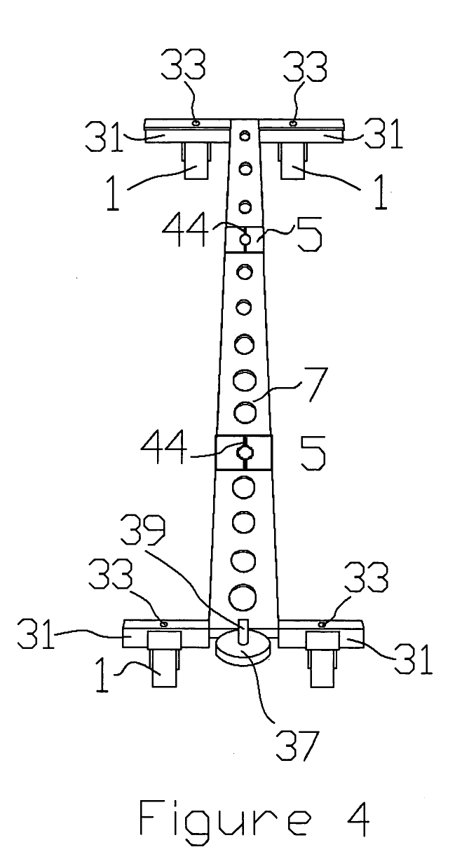

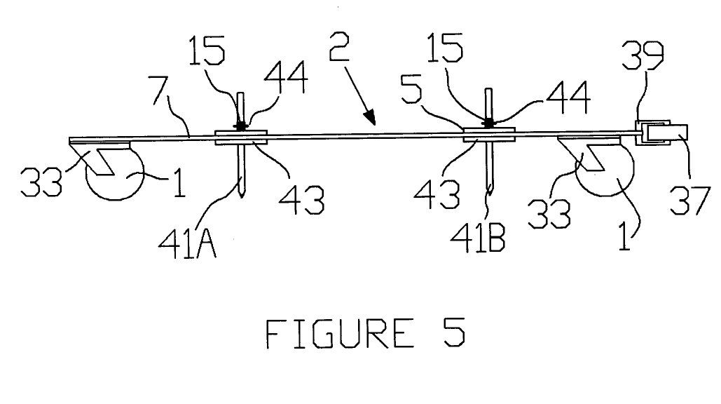

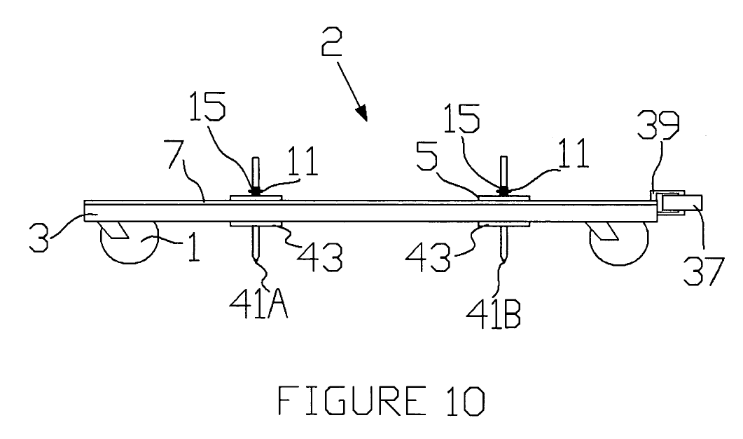

FIGS. 3 and 4 depict a second embodiment of the invention. In this embodiment, the adjustment plate 7 includes a plurality of holes 21 that are positioned at a predetermined distance between one another. That is to say, each hole is located equidistance from its neighboring hole(s). For example, each hole 21 may be spaced approximately one-half an inch from another neighboring hole. Marking devices or pointers 41A and 41B, as shown in FIGS. 5 and 10, are inserted through the threaded plate extensions 15. Two wing nut assemblies 44 are shown as being used in the present embodiment. However, it should be noted that the wing nut assemblies are unnecessary for practicing the invention in this embodiment. The diameter of each hole 21 may be slightly larger than the cross sectional diameter of a marking device 41 such that the marking device is held securely within a hole 21 without the need for a wing nut assembly 44.

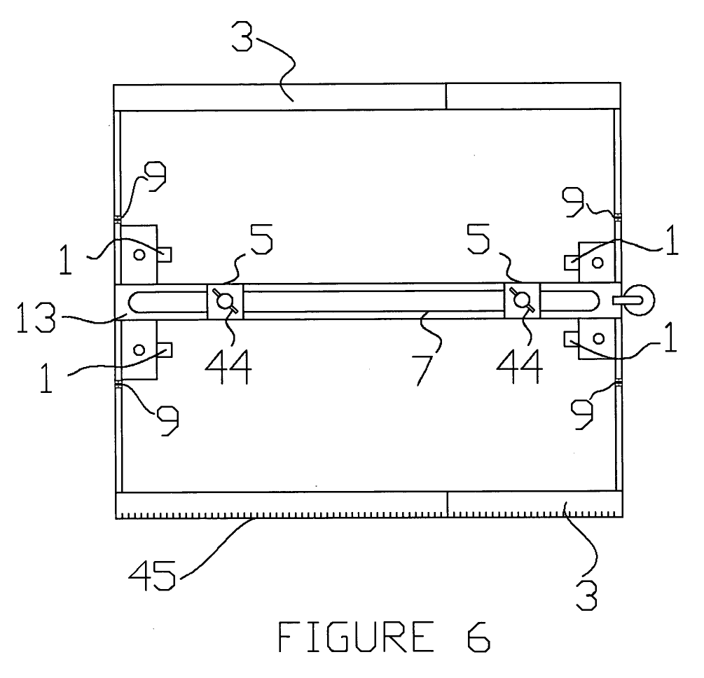

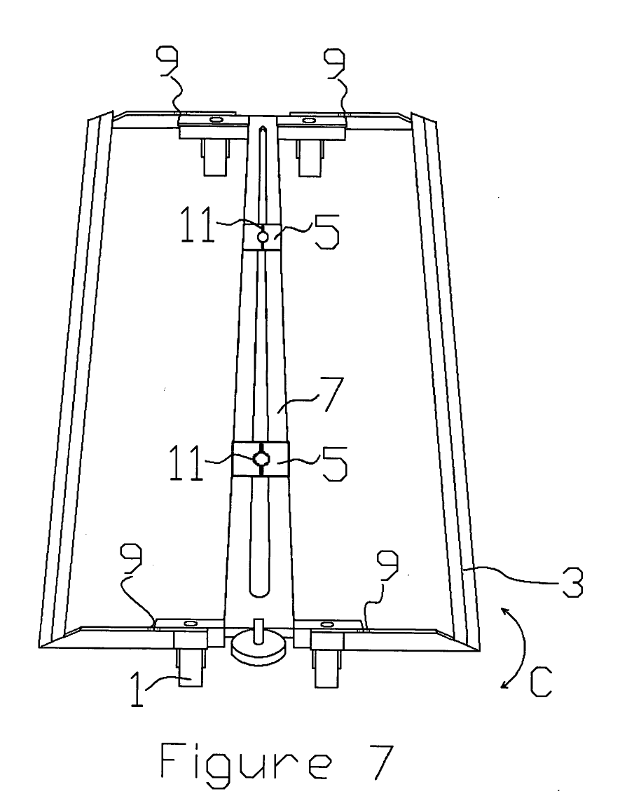

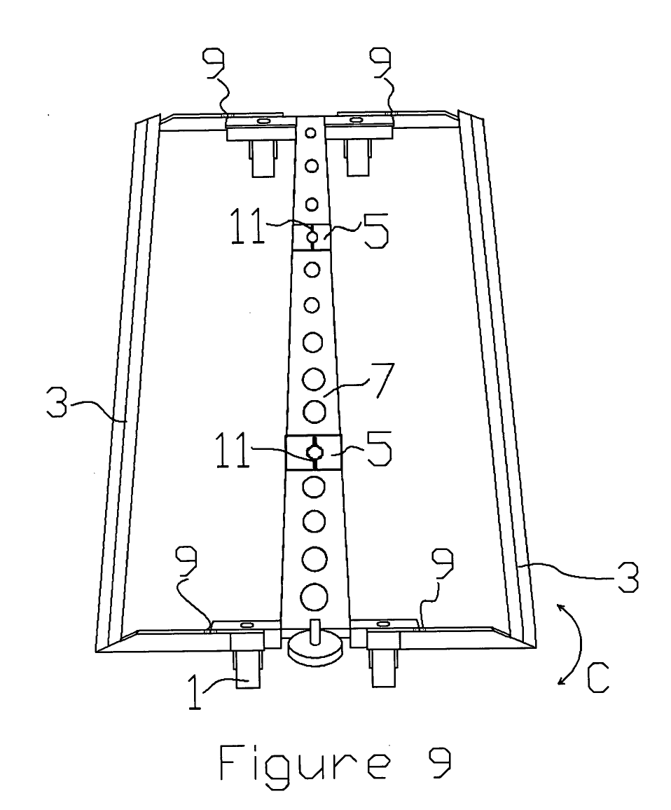

Now turning to FIGS. 6 through 10 which include a third and fourth embodiment of the invention. In this embodiment, the scribing tool 2 is equipped with four wheels 1 that work to maneuver the apparatus into the necessary positions while making marks with the marking device (not shown). The marking device 41, most likely a pencil or marker, will make the actual mark on the floor covering to be cut. The side straight edges 3 function as rulers and include graduated edges 45 to enable the user to measure and mark the covering or floor as desired. Graduated marks may also be included on the adjustment plate 7. The wing nut assembly 5 securely holds the marking device 41 in place during use of the tool 2.

In the third embodiment as shown in FIG. 6, a wing nut assembly 44 holds the marker 41 in place and allows the user to adjust side straight edge 3 to assume various angles within a range of substantially 125 degrees. That is to say, edge 3 may be positioned vertical with respect to plate 7. Alternatively, it may be declined in elevation such that it rests upon the floor and against the area where the floor meets the wall.

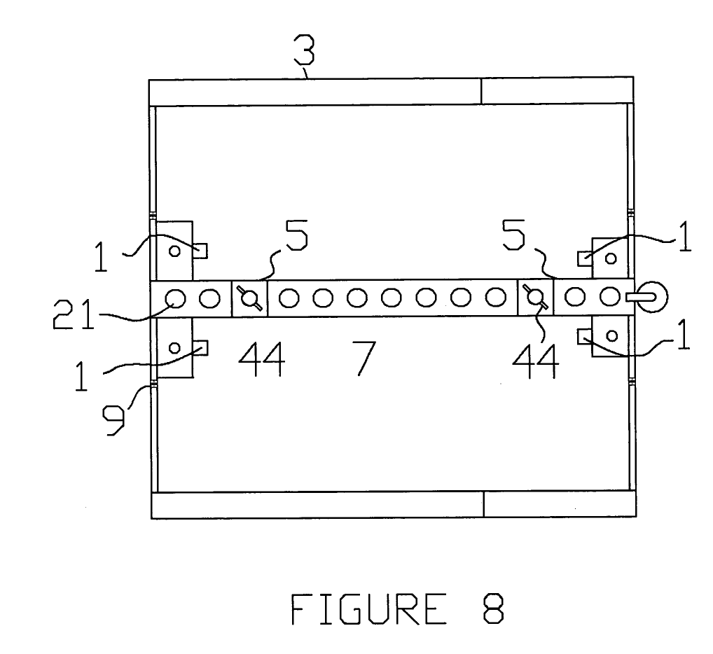

FIG. 8 shows a fourth embodiment of the invention. In this embodiment, the adjustment plate 7 is similar to the one described in the second embodiment. Side straight edges 3 are included as in the third embodiment. In this embodiment, a series of graduated holes along the plate 7 allows the user to insert a marker 41 into the one of the desired holes 21 to make a mark. The plate 7 may include graduated marks. The tool 2 can be manipulated to many different positions to ensure that the user can use it for whatever angles or uses are necessary. The hinges 9 make the tool 2 more versatile by letting the whole tool transform to different elevations. The tool 2 may fit more easily into various positions and is available for making more difficult measurements.

FIG. 11 depicts an exploded view of the wing nut assembly 44. The assembly 44 includes a wing nut 11 that comprises internal threads (not shown). A bottom plate 43 includes a hollow threaded portion 15 that comprises external threads. The hollow threaded portion 15 is inserted through one of the openings in the adjustment plate 7. A washer plate 5 comprising a central hole is slid over the hollow threaded extension 15. The wing nut 11 is threaded onto the hollow threaded extension 15. The marker 41 is inserted into the hollow extension 15. The wing nut 11 is tightened to exert pressure against the washer plate 5 whilst pulling plate 43 towards the wing nut 11 such that each compresses against plate 7 to secure the assembly 44 against the adjustment plate 7. In the first and third embodiments of the invention, the wing nut 11 is loosened to allow the assembly 44 to be moved to a desired location along the adjustment plate 7. Thereafter, the wing nut 11 is tightened to secure the assembly in the desired location.

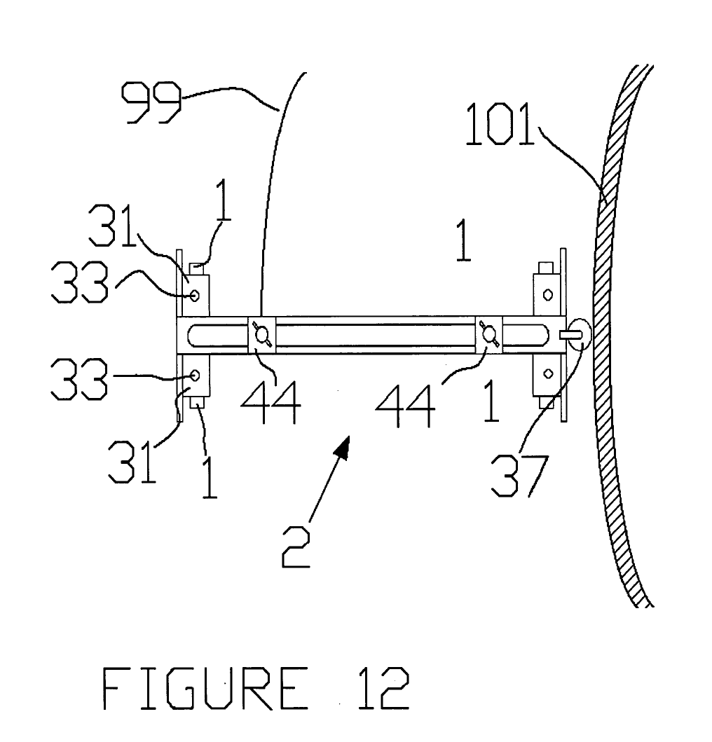

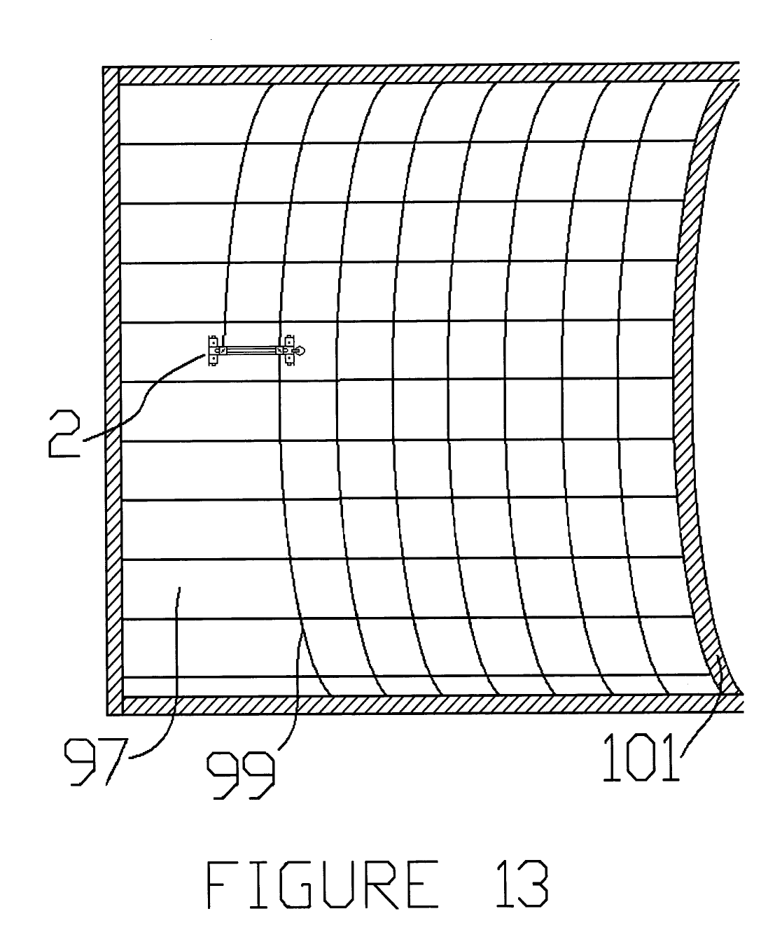

FIG. 12 depicts one use of the tool 2. The tool 2 glides along curved surface 101 to create a mark 99 as shown. It can be readily understood by those skilled in the art that the tool 2 may include two or more assemblies 44 to create multiple marks 99 on the floor 97 or flooring surface. In FIG. 13, the tool is scribing marks for use in placing tiles to account for curvature or imperfections in the surface of a wall.

While the invention has been described with respect to preferred embodiments, it is apparent to those skilled in the art that changes, modifications and additions may be made to the herein described embodiments without departing from the scope of the invention. Accordingly, it is intended that all matter contained in the above description or shown in the accompanying drawings shall be interpreted as illustrative and not in limiting sense or use.

1. A scribing tool comprising:
an adjustment plate having two ends and including at least one opening;
a pair of wheels affixed at each end of the adjustment plate; and
a marker adjustably affixed in said adjustment plate within said at least one opening.

2. The scribing tool of claim 1 wherein said at least one opening is an elongated opening.

3. The scribing tool of claim 1 wherein said adjustment plate includes a plurality of holes spaced equidistance from each other.

4. The scribing tool of claim 1 further comprising a wing nut assembly.

5. The scribing tool of claim 4 wherein said wing nut assembly includes a wing nut, a washer plate and a bottom plate.

6. The scribing tool of claim 5 wherein said wing nut is threaded onto a hollow threaded extension that extends from said bottom plate.

7. The scribing tool of claim 1 further including swivels that affix said wheels to said adjustment plate.

8. The scribing tool of claim 1 further comprising an adjustable straight edge connected to said adjustment plate via a hinge.

9. A scribing tool for marking flooring coverings to be cut comprising:
an adjustment plate having a first end and a second end;
at least one side straight edge hingeably connected to said scribe holder plate;
a first pair of wheels attached at the first end of said adjustment plate;
a second pair of wheels attached at the second end of the adjustment plate; and
a marker holder adjustably attached to said adjustment plate.

10. The scribing tool of claim 9 further comprising:
graduated marks provided on said straight edge.

11. A scribing tool for marking floor coverings to be cut comprising:
a adjustment plate for accommodating a marker;
a straight edge connected to said adjustment plate; and
at least one pair of wheels attached to said adjustment plate.
